(19) United States
(12) Patent Application Publication
(10) Pub. No.: US 2007/0174098 A1
(43) Pub. Date: Jul. 26, 2007

(54) Business context sensitive attribute override

(76) Inventors: Lev Mirtas, Thornhill (CA); Victor Chan, Thornhill (CA); Aalim Lakhani, Thornhill (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/336,249

(22) Filed: Jan. 20, 2006

(51) Int. Cl. G06F 17/50

(52) U.S. Cl. 705/7

(57) ABSTRACT

A context sensitive object attribute override method includes retrieving an object attribute responsive to a request for the object attribute in a transaction in a commerce system, determining whether a context for the transaction is associated with an overridden form of the object attribute, and overriding the object attribute with the overridden form if the context for the transaction is associated with the overridden form of the object attribute.

### BACKGROUND OF THE INVENTION

The present invention relates to the field of commerce computing and more particularly to context driven component based commerce systems.

As businesses and consumers become further interconnected through computer communications networks such as the global Internet and local intranets, the commerce sites and companion computing applications which integrate interactions between businesses and consumers alike can become ever more complex. Addressing the explosion of business to business and business to consumer interactions on-line, information technologists increasingly focus on architecting and implementing complete commerce site solutions to reflect the entire life cycle of a business in lieu of integrating multiple, disparate applications which when combined reflect the business life cycle. Consequently, as modern commerce sites can be both large and distributed, commerce systems have been configured to deploy complete e-commerce systems in as seamless a fashion as possible.

It is now a common trend that traditional, stand-alone, commerce oriented applications are produced from one or more components which can be individually re-used to create business processes for different solutions. Each of these components can expose itself as a set of services comporting with computing standards for deploying enterprise level logic that facilitate an open service oriented architecture (SOA). An SOA essentially can be defined as a collection of services. These services communicate with each other, which communication can involve either simple data passing between two or more services, activity coordinating by two or more services.

In an SOA, a client can invoke a service within a component to perform an operation and, optionally the client can receive a response. Invoked services generally can include business services configured to fulfill the needs of business customers, whether those customers are individual consumers or other businesses. The services can be grouped into various SOA components where each component can specialize in functions such as catalog management, shopping cart management, credit card transaction processing, sales tax computation and the like.

Within a commerce model, stateless transactions can be combined to form an activity in the aggregate. The context of the activity can be maintained centrally by the commands forming the basis of the commerce system implementing the commerce model. The context can include aspects of an activity such as the parties to the activity, the resources supporting the completion of the activity, and the medium of the activity. For example, contextual data can include a customer classification, a store identifier, a common language identifier, or a currency type.

Given the varying potential contexts for a transaction in an SOA component, different SOA components must be written to accommodate the different potential contexts. The different SOA components can vary for different contexts according to logic performed and data accessed. In regard to the latter, values for content in a content repository can vary from context to context, while the data structure for the values can remain constant. For example, pricing values, SKU numbers and other attributes for goods and services in a content repository can vary according to customer classification though the data structure for the different content repositories can remain the same. Specifically, some customers are entitled to lower prices for the same good or service than other customers. Other customers prefer a customized SKU which differs for the same good or service from other customers.

### BRIEF SUMMARY OF THE INVENTION

In one embodiment of the invention, a method can include retrieving an object attribute responsive to a request for the object attribute in a transaction in a commerce system, determining whether a context for the transaction is associated with an overridden form of the object attribute, and overriding the object attribute with the overridden form if the context for the transaction is associated with the overridden form of the object attribute.

In another embodiment of the invention, a component based data processing system enabled for context-sensitive overriding of object attributes can include a commerce system hosting a component based application including at least one component comprising business logic and data access logic. The system also can include a business context engine providing business context services to the component based application in the commerce system. Finally, the data processing system can include override logic coupled to the data access logic. The override logic can include program code enabled to override a requested object attribute in a transaction with an overridden form of the object attribute if a context for the transaction is associated with the overridden form of the object attribute.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

FIG. 1 is a schematic illustration of a commerce system configured to manage business context services for adaptable SOA components;

FIG. 2 is a block diagram illustrating a process for utilizing the business context services of the commerce system of FIG. 1;

FIG. 3 is a block diagram illustrating a process for context-sensitive overriding object attributes in a commerce system; and,

FIG. 4 is a flow chart illustrating a process for context-sensitive overriding object attributes in a commerce system.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

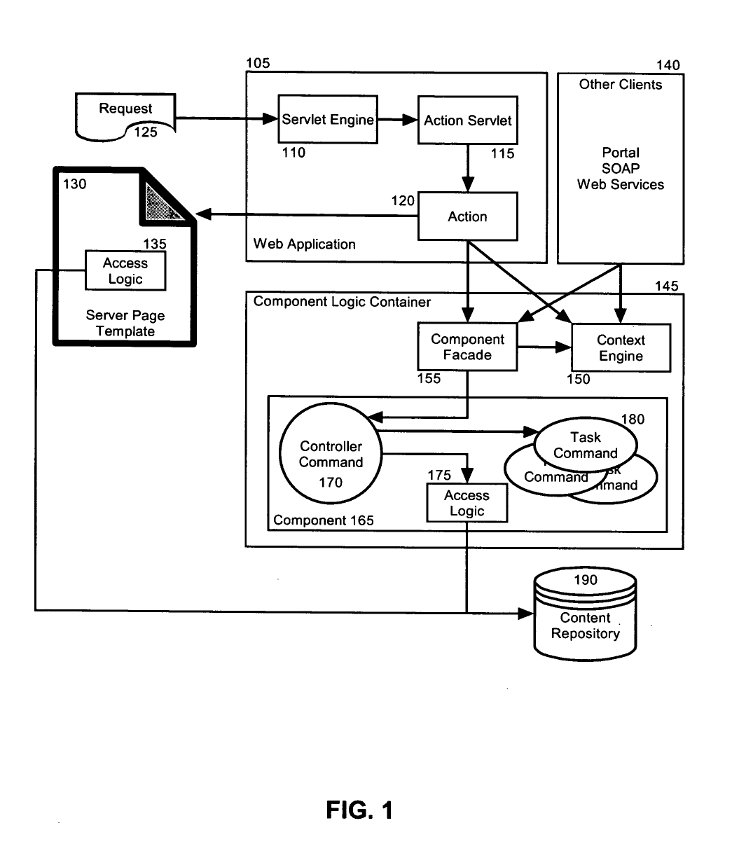

Notably, the method, system and computer program for the context sensitive overriding on an object attribute can support a context sensitive commerce system providing business context services through adaptable SOA components. In illustration, FIG. 1 schematically depicts an exemplary albeit non-exclusive commerce system configured to manage business context services for adaptable SOA components. The commerce system can include one or more service invoking client platforms including a Web application 105, as well as other clients 140 such as a portal client, simple object access protocol (SOAP) client, and a Web services client to name a few. For purposes of illustrative efficiency, only a Web application 105 is shown in detail.

The Web application 105 can be communicatively coupled to a component logic container 145 which in turn can be communicatively coupled to persistent storage 190. The Web application 105 can host a servlet engine 110 which can process requests 125 for commerce services through an action servlet 115. The action servlet 115, in turn, can be configured to invoke actions 120 logically linked both to a commerce application view 130 and also to a component facade 155 programmed to invoke business logic within one or more components 165 disposed with the component logic container 145.

For instance, the component facade 155 can be a component stateless session bean (SSB) logically coupled to one or more components 165 which when combined form a commerce system solution. Each of the components 165 can include a controller command 170 having one or more task commands 180. The controller command 170 further can be logically linked to access logic 175 configured to access persisted data in a content repository 190 which conforms to a common data structure. Similarly, the commerce application view 130 can include access logic 135 likewise configured to access persisted data in the content repository 190.

Notably, the component facade 155 can be coupled to a business context engine 150. The business context engine 150 can manage an activity, where the activity can include a series of consecutive requests 125 from one or more service clients, in order to treat the consecutive series of requests 125 as a single conversation as between the service clients and the commerce system service defined by the components 165. The context engine 150 is responsible for managing the business contexts associated with an activity.

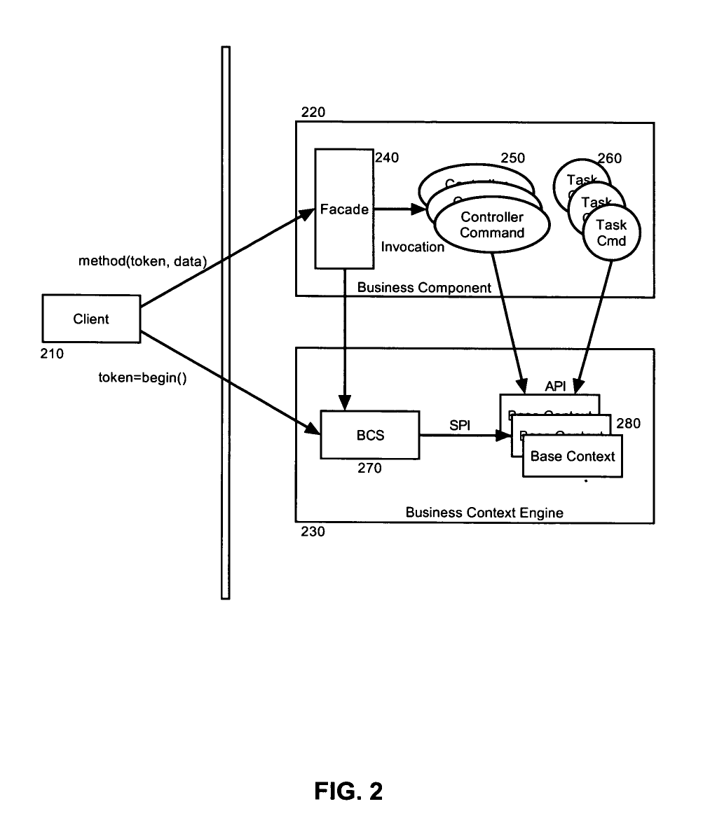

As it will be apparent from the schematic illustration of FIG. 1, the SOA of FIG. 1 can be divided into two main parts: the context engine and the component service. The context engine provides context related services while the component service provides a facade to the commands and facilities to instantiate and execute a command in the commerce system. In more particular illustration, FIG. 2 is a block diagram illustrating a process for utilizing the business context services of the commerce system of FIG. 1 in the course of executing the business logic of a system component.

As shown in FIG. 2, a client computing process 210 can establish a communicative linkage to a business component 220 in addition to a business context engine 230. The business component 220 can include a component facade 240 through which business logic in the form of controller commands 250 and underlying task commands 260 can be invoked. The business context engine 230, in turn, can include a business context service 270 coupled to one or more business contexts 280.

In operation, the client computing process 210 can obtain an activity token from the business context engine 230 which can include a specific set of business contexts. The client computing process 210 subsequently can pass the activity token to the business component 220 in the course of a business task in order to provide contextual information for completing the task. For instance, the business component 220 further can access elements of the business contexts 280 by way of an application programming interface (API) to the business context engine 230 utilizing the specific information of the activity token.

Specifically, to invoke a method on a business component, a client 210 or component facade 240 can obtain an activity token by first making a call to the interface of the business context service 270. In the process of obtaining the activity token, the client 210 or component facade 240 optionally can supply initialization data that can be used to populate pre-loaded contexts during creation of a new activity. Subsequently, the client 210 can pass the activity token to the component facade 240 when a particular method is invoked on the interface to the business component 220.

Notably, the activity token can be used to associate a set of contexts in effect during particular client requests to the various business components. The client can supply the activity token on every request to indicate the experience that the client would like from the business components. These contexts can include, by way of example, a solutions context indicating whether a requested operation in an activity is to be performed by a specified entity, or through an entity which acts on behalf of a specified entity. The contexts also can include a globalization context providing globalization information, an entitlement context providing information for promotional entitlement programs, a content context providing versioning information for specified content, a task context indicating a current task or state for a process having multiple tasks, and an audit context providing auditing information, to name only a few contexts.

Advantageously, unlike conventional commerce system implementations in which the context of an activity is maintained centrally in a command context, in the present invention, the context of a business task can be maintained across one or more business contexts which can be incorporated into or referenced by activity tokens passed between the different business components when processing the task. Consequently, the state of each business context can be maintained across requests and transactions so that a significant performance improvement can be realized.

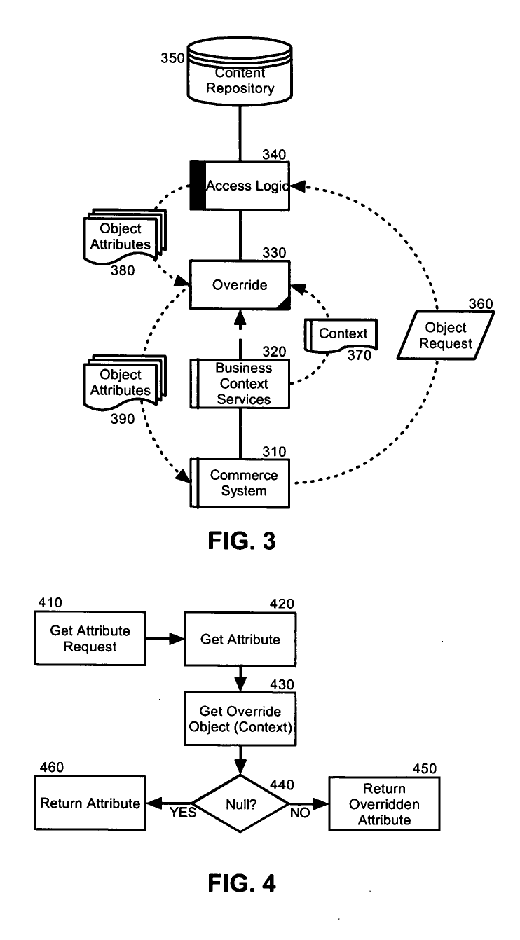

Importantly, the business contexts 280 can be utilized in overriding object attributes in a content repository during a transaction performed by logic within the business component 220. In further illustration, FIG. 3 is a block diagram illustrating a process for context-sensitive overriding object attributes in a commerce system. As shown in FIG. 3, a data processing system configured for context sensitive attribute overriding can include a commerce system 310 including business context services 320. The commerce system 310 can be communicatively coupled to a content repository 350 through access logic 340. Objects utilized in the operation of the commerce system 310 can be accessed by the commerce system 310 in the content repository 350.

Importantly, override logic 330 can be coupled to access logic 340. The override logic 330 can include program code enabled to process object attributes 380 retrieved in response to an object request 360 provided by the commerce system 310 in the course of a transaction according to a context 370 for the transaction. Specifically, the program code of the override logic 330 can be enabled to selectively override the retrieved object attributes 380 with alternative object attributes 390 depending upon the context 370 of the transaction. To that end, the override logic 330 can access an override table (not shown) to determine whether the context 370 is to override the retrieved object attributes 380.

To support the operation of the override logic 330, a schema override design can be provided to support table level overriding of object attributes. The schema override design can include an override table incorporating selected fields holding object attributes values in an associated table of object attributes which are to be overridden. Additional fields can be included in the override table including a context identifier and context type. Each context identifier can be associated with an object represented by a selected record in the associated table. Where an association is provided, overridden values for object attributes can be specified as values for fields in the associated table. Optionally, a null value for a field in a selected record indicates that the field value for the selected record is not to be overridden for the context associated with the context identifier.

Utilizing the schema design, retrieved object attributes for an object can be selectively overridden dependent upon the context of an associated transaction. More importantly, the retrieved object attributes for an object can be selectively overridden without the knowledge of the end user in that the overriding can occur seamlessly in the course of satisfying an object request. In more specific illustration, FIG. 4 is a flow chart illustrating a process for context-sensitive overriding object attributes in a commerce system. Beginning in block 410, an attribute request can be received for an object attribute for an object in the course of a transaction. For example, a request can be received to retrieve a product description, price or product number for a product. The attribute can be retrieved in block 420 and in block 430 an override object can be created for the object by providing a context for the transaction.

The override table of the schema can be consulted and if the context has provided for an overridden object attribute, the overridden attribute can be specified in the override object. In decision block 440, it can be determined whether the requested object attribute in the override object is null. If not, it is presumed that an overridden attribute has been specified according to the context. As such, in block 450 the overridden attribute can be returned to the requester in lieu of the retrieved attribute. Otherwise, it can be presumed that no overridden attribute has been specified according to the context. As such, in block 460 the retrieved attribute can be returned to the requester.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

We claim:

1. A method comprising:
retrieving an object attribute responsive to a request for the object attribute in a transaction in a commerce system;
determining whether a context for the transaction is associated with an overridden form of the object attribute; and,
overriding the object attribute with the overridden form when the context for the transaction is associated with the overridden form of the object attribute.

2. The method of claim 1, wherein retrieving an object attribute responsive to a request for the object attribute in a transaction in a commerce system, comprises retrieving one of a product price, product description and product number responsive to a request for a respective one of a product price, product description and product number in a transaction in a commerce system.

3. The method of claim 1, wherein determining whether a context for the transaction is associated with an overridden form of the object attribute, comprises determining whether a customer identity for the transaction is associated with an overridden form of the object attribute.

4. The method of claim 1, wherein determining whether a context for the transaction is associated with an overridden form of the object attribute, comprises determining whether a customer contract for the transaction is associated with an overridden form of the object attribute.

5. The method of claim 1, wherein determining whether a context for the transaction is associated with an overridden form of the object attribute, comprises consulting an override table to identify an overriden form for the object attribute.

6. The method of claim 1, wherein determining whether a context for the transaction is associated with an overridden form of the object attribute, comprises:
constructing an override object inherited from an object for the object attribute utilizing the context; and,
determining whether an overridden attribute in the override object corresponding to the object attribute of the object has a null value for the context.

7. A component based data processing system enabled for context-sensitive overriding of object attributes, the system comprising:
a commerce system hosting a component based application comprising at least one component comprising business logic and data access logic;
a business context engine providing business context services to the component based application in the commerce system; and,
override logic coupled to the data access logic, the override logic comprising program code enabled to override a requested object attribute in a transaction with an overridden form of the object attribute when a context for the transaction is associated with the overridden form of the object attribute.

8. The component based data processing system of claim 7, wherein the component based data processing system has a service oriented architecture (SOA).

9. The component based data processing system of claim 7, wherein the business logic of the at least one component comprises a controller command coupled to at least one task command.

10. A computer program product comprising a computer usable medium having computer usable program code embodied herewith, the computer usable program code comprising:
computer usable program code for retrieving an object attribute responsive to a request for the object attribute in a transaction in a commerce system;
computer usable program code for determining whether a context for the transaction is associated with an overridden form of the object attribute; and,
computer usable program code for overriding the object attribute with the overridden form when the context for the transaction is associated with the overridden form of the object attribut.

11. The computer program product of claim 10, wherein the computer usable program code for retrieving an object attribute responsive to a request for the object attribute in a transaction in a commerce system, comprises computer usable program code for retrieving one of a product price, product description and product number responsive to a request for a respective one of a product price, product description and product number in a transaction in a commerce system.

12. The computer program product of claim 10, wherein the computer usable program code for determining whether a context for the transaction is associated with an overridden form of the object attribute, comprises computer usable program code for determining whether a customer identity for the transaction is associated with an overridden form of the object attribute.

13. The computer program product of claim 10, wherein the computer usable program code for determining whether a context for the transaction is associated with an overridden form of the object attribute, comprises computer usable program code for determining whether a customer contract for the transaction is associated with an overridden form of the object attribute.

14. The computer program product of claim 10, wherein the computer usable program code for determining whether a context for the transaction is associated with an overridden form of the object attribute, comprises computer usable program code for consulting an override table to identify an overridden form for the object attribute.

15. The computer program product of claim 10, wherein the computer usable program code for determining whether a context for the transaction is associated with an overridden form of the object attribute, comprises:
computer usable program code for constructing an override object inherited from an object for the object attribute utilizing the context; and,
computer usable program code for determining whether an overridden attribute in the override object corresponding to the object attribute of the object has a null value for the context.
